(19) United States
(12) Patent Application Publication
(10) Pub. No.: US 2002/0181104 A1
(43) Pub. Date: Dec. 5, 2002

(54) Bicycle rider expandable reflective strap worn around arms, legs and waist

(76) Inventor: Karen D. Gonzales, Denver, CO (US)

Correspondence Address: EDWIN H. CRABTREE, Suite 575, 3773 CHERRY CREEK N. DR., DENVER, CO, 80209, US

(21) Appl. No.: 09/873,961

(22) Filed: Jun. 4, 2001

(51) Int. Cl. G02B 5/12

(52) U.S. Cl. 359/517; 359/519

(57) ABSTRACT

A bicycle rider expandable light reflective strap which can be worn around the arms, legs, waist or wrist of a bike rider. Also, the strap can be used for receipt around the frames or handle bars of a bicycle or scooter. The light reflective strap provides for increase safety when ridding in traffic, at night and when traveling during poor weather conditions. The light reflective strap is expandable and retractable and can be coupled together with another light reflective strap for forming various sizes of a light reflective belt. The bicycle rider expandable light reflective strap or straps include a flexible webbing with one or more parallel light reflective stripes along the length of the webbing. The stripes are used for reflecting light thereon. A first end of the webbing is attached to a first female attachment buckle, A second end of the webbing is looped through a portion of a first male attachment buckle and attached to a webbing length adjustment slide. The length adjustment slide is used for adjusting the length of the webbing in a range of 6 to 24 inches.

### BACKGROUND OF THE INVENTION

(a) Field of the Invention

This invention relates to reflective webbing or straps used for reflecting light during night time and more particularly, but not by way of limitation, to a bicycle rider expandable reflective strap. The reflective strap can be worn on the rider's arms, legs, added to a waist strap or used as a belt for reflecting light and providing safety and increased visibility when riding at night and riding during poor visibility conditions.

(b) Discussion of Prior Art

Heretofore, there have been a variety of different types of reflective safety belts and reflective straps worn by humans and providing light reflection and a safety alert to approaching traffic. Also reflective collars and reflective leashes are used for animal safety.

In U.S. Pat. Nos. 4,534,619 and 4,653,853 to Bedford, a reflective safety belt is described. The belt is formed in an “X” shape and worn on the back or chest of the wearer. In U.S. Pat. No. 4,601,538 to Valkenburg, a light reflecting safety belt is described and used by pedestrians and cyclists. In U.S. Pat. Nos. 6,059,414 to Tsai, 3,276,416 to Dirks et al., 3,134,548 to Medina et al., 5,169,702 to Schell, and 1,739,289 to Carti, different types of reflective devices, safety belts and reflective warps are disclosed. In U.S. Pat. No. 4,384,548 to Cohn, a flexible webbing with reflective threads is described for use in making animal collars and leashes.

In U.S. Pat. No. 5,979,722 to the subject inventor, a combination backpack and splash guard is described. The combination backpack and splash guard is used for carrying various items when bicycling and preventing water and mud from splashing on the back and seat of a bike rider. This unit also includes reflective fabric and straps for enhanced visibility when riding at night and during poor weather conditions. The invention described herein can be used with the combination backpack and splash guard for waist expansion worn by the bike rider when bicycling for increased visibility.

None of the above mentioned reflective devices, reflective safety belts and reflective clothing disclose the unique features, objects and advantages of the subject expandable reflective strap and combination of connected reflective straps for use on various locations on the body of a bicycle rider.

### SUMMARY OF THE INVENTION

In view of the foregoing, it is a primary objective of the subject invention to provide a light reflective strap worn by a bicycle rider for increased safety when riding in traffic, at night and when traveling during poor weather conditions.

Another object of the invention is the light reflective strap is expandable and retractable for use on the legs, arms and waist of the bike rider. Also, the reflective strap can be coupled together with another reflective strap for forming various sizes of a light reflective belt.

Still another object of the reflective strap is the length of the strap is infinitely adjustable for various arm, leg and waist sizes.

A further object of the invention is one or more straps can be wrapped around and attached to the frames and/or handle bars of bikes and scooters.

Yet another object of the invention is the reflective strap can be used with a bicycle backpack and splash guard for providing additional width to existing adjustable reflective waist straps.

The bicycle rider expandable reflective strap or straps include a flexible webbing with one or more parallel light reflective stripes along the length of the webbing. The stripes are used for reflecting light thereon. A first end of the webbing is attached to a first female attachment buckle. A second end of the webbing is looped through a portion of a first male attachment buckle and attached to a webbing length adjustment slide. The length adjustment slide is used for adjusting the length of the strap in a range of 6 to 24 inches. The first male attachment buckle can be used for releasable attachment to the first female attachment buckle or coupled together with a second female attachment buckle when two or more of the reflective straps are joined together.

These and other objects of the present invention will become apparent to those familiar with different types of reflective devices, reflective safety belts and the like when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a perspective view of a first bicycle rider expandable light reflective strap with flexible webbing and a pair of light reflective stripes along the length of the webbing. The first strap is shown with a first female attachment buckle, a first male attachment buckle and a length adjustment slide used for adjusting the length of the webbing on the strap.

FIG. 2 is another perspective view of the first bicycle rider expandable light reflective strap with the first male attachment buckle positioned for releasable engagement with the first female attachment buckle.

FIG. 3 is a perspective view of a bicycle rider with the expandable light reflective strap attached around a wrist, around an upper arm and a pair of straps joined together and used as a belt around a waist.

FIG. 4 is another perspective view of the bicycle rider with a pair of the expandable light reflective straps received around the pant legs of the bicycle rider.

FIG. 5 is a perspective view of the bicycle rider with the expandable light reflective strap used with reflective straps, which are also part of a combination backpack and splash guard. In this example, the light reflective strap is used for expanding the waist size of the backpack and splash guard.

### DESCRIPTION OF THE PREFERRED EMBODIMENTS

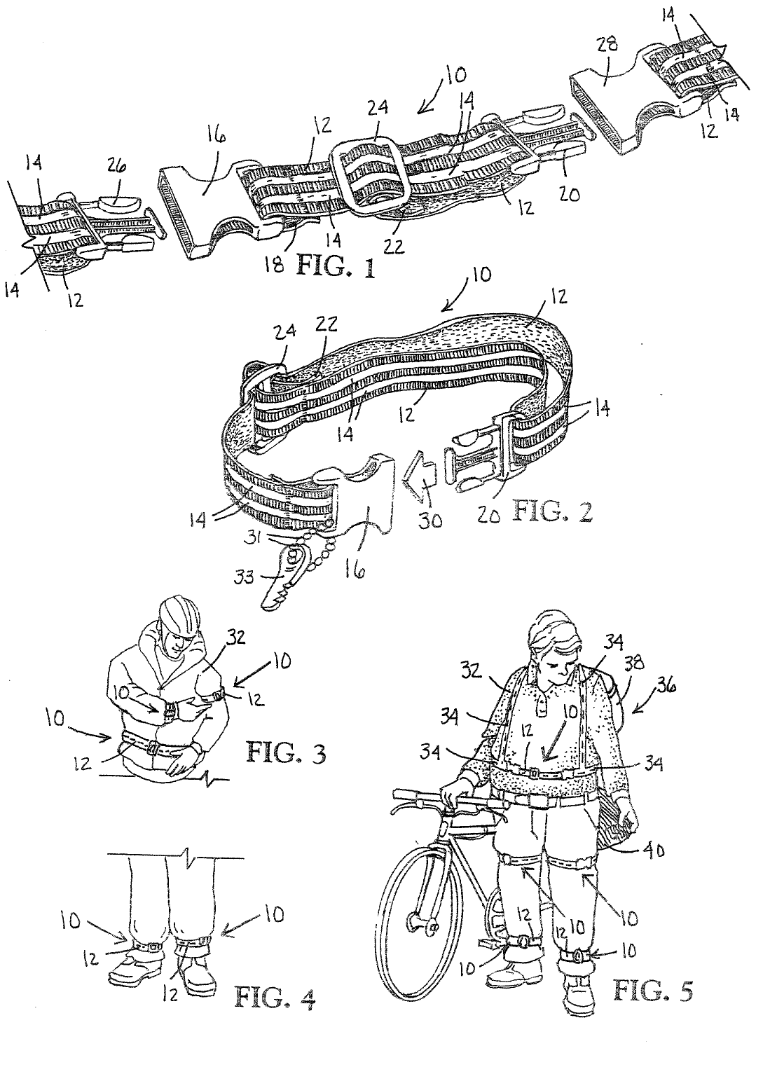

In FIG. 1, a perspective view of a first bicycle rider expandable light reflective strap is shown and having general reference numeral 10. The first strap 10 includes a flexible webbing 12 with one or more light reflective stripes 14 along the length of the webbing 12. In the drawings, the webbing 12 is shown having a pair of parallel light reflective stripes 14. The strap 10 also includes a first female attachment buckle 16 attached to a first end 18 of the webbing 12. The webbing 12 is weaved through a portion of a first male attachment buckle 20 and looped back along the back side and length of the webbing with a second end 22 of the webbing 12 attached to a length adjustment slide 24. The length adjustment slide 24 is used for expanding and contracting the length of the webbing 12, thus providing the strap 10 with a variable length in a range of 6 to 24 inches.

Also shown in FIG. 1, is a second light reflective strap 10 with a second male attachment buckle 26 attached to a portion of the webbing 12 and positioned for releasable attachment to the first female attachment buckle 16. The second light reflective strap 10 has the same structure and function as the first light reflective strap 10 and is used for increasing the strap's overall length when used, for an example, as a belt. The combination of the two straps 10 can accommodate waist sizes, when contracted using the slide 24, of under 24 inches. Also, when the two straps 10 are coupled together, they can accommodate waist sizes, when expanded using the slide 24, up to 46 inches. The second strap 10 shown in this drawing includes a female attachment buckle 28 attached to a portion of the webbing 12 and positioned for releasable attachment to the first male attachment buckle 20.

In FIG. 2, another perspective view of the first bicycle rider expandable light reflective strap 10 is shown. In this figure, the first male attachment buckle 20 is positioned, as indicated by arrow 30, for releasable engagement with the first female attachment buckle 16.

Also shown in this drawing is a key chain 31, which is looped through a portion of the first female attachment buckle 16. The key chain 31 is shown holding a key 33 thereon. In this example, the subject invention can be used for holding the key chain 31 as shown or holding a key ring and the like and worn around a person's wrist when carry keys while bicycling.

In FIG. 3, a perspective view of a bicycle rider 32 is illustrated. The rider 32 is shown with the expandable light reflective strap 10 attached around his coat and upper arms for enhanced visibility when riding at night and other ridding conditions. Also, one of the straps 10 is received around the rider's wrist. Further, a pair of the straps 10 are joined together and used a belt received around the rider's waist.

In FIG. 4, another perspective view of the bicycle rider 32 is shown with a pair of the expandable light reflective straps 10 received around his pant legs for providing pant guards when riding a bicycle along with increased visibility.

In FIG. 5, a perspective view of the expandable light reflective strap 10 is shown and used with light reflective straps 34 which are part of a combination backpack and splash guard. The combination backpack and splash guard are shown having a general reference numeral 36. The combination backpack and splash guard 36 broadly include a backpack 38 and a splash guard 40. The splash guard 40 is adjustable in length and extends downwardly from the backpack for covering the back and seat of the bicycle rider 32, when riding through wet areas. In this example, the subject invention is used for releasable attachment to the reflective straps 34 and expanding the waist size of the combination backpack and splash guard 36. The rider 32 is shown in this drawing with the expandable reflective straps 10 around his upper and lower legs for pant guards. Obviously, the light reflective straps 10 not only provide additional visibility during poor lighting conditions, but also provide for preventing pants from getting caught in a bicycle chain when riding a bicycle.

The embodiments of the subject invention for which exclusive privileges and property rights are claimed are defined as follows:

1. A bicycle rider expandable light reflective strap worn around the arms, legs, waist and wrist of a bike rider, the light reflective strap provides for increased safety when riding in traffic at night and during poor weather conditions, the strap comprising:
a flexible webbing with at least one light reflective stripes along the length of said webbing;
a female attachment buckle, one end of said webbing attached to said female attachment buckle;
a male attachment buckle, said webbing looped through a portion of said male attachment buckle; and
a length adjustment slide, an opposite end of said webbing attached to said length adjustment slide, said length adjustment slide used for expanding and contracting the length of said flexible webbing.

2. The strap as described in claim 1 wherein said length adjustment slide adjusts the length of the strap in a range of 6 to 24 inches.

3. The strap as described in claim 1 wherein said flexible webbing includes a pair of parallel light reflective stripes, said stripes disposed along the length of said webbing.

4. The strap as described in claim 1 wherein said female attachment buckle and said male attachment buckle are adapted for releasable attachment to light reflective straps on a combination backpack and splash guard for increasing the waist size of the combination backpack and splash guard.

5. A bicycle rider expandable light reflective strap worn around the arms, legs, waist or wrist of a bike rider or wrapped around a frame or handle bar of a bicycle or scooter, the light reflective strap provides for increased safety when riding in traffic at night and during poor weather conditions, the strap comprising:
a flexible webbing with at least one light reflective stripes along the length of said webbing;
a female attachment buckle, one end of said flexible webbing attached to said female attachment buckle;
a male attachment buckle, said flexible webbing looped through a portion of said male attachment buckle; and
a length adjustment slide, an opposite end of said flexible webbing attached to said length adjustment slide, said length adjustment slide used for expanding and contracting the length of said flexible webbing in a range of 6 to 24 inches.

6. The strap as described in claim 5 wherein said flexible webbing includes a pair of parallel light reflective stripes, said stripes disposed along the length of said webbing.

7. The strap as described in claim 5 wherein said female attachment buckle and said male attachment buckle are adapted for releasable attachment to light reflective straps on a combination backpack and splash guard for increasing the waist size of the combination backpack and splash guard.

8. The strap as described in claim 5 further including a key chain attached to a portion of said female attachment buckle, said key chain used for holding keys and other items thereon.

9. A pair of bicycle rider expandable light reflective straps for use as a reflective belt, the light reflective straps provide for increase safety when riding in traffic, at night and during poor weather conditions, the straps comprising:
a first flexible webbing with at least one light reflective stripes along the length of said first flexible webbing;
a first female attachment buckle, one end of said first flexible webbing attached to said first female attachment buckle;
a first male attachment buckle, said first flexible webbing looped through a portion of said first male attachment buckle;
a first length adjustment slide, an opposite end of said first flexible webbing attached to said first length adjustment slide, said first length adjustment slide used for expanding and contracting the length of said first flexible webbing;
a second flexible webbing with at least one light reflective stripes along the length of said second flexible webbing;
a second female attachment buckle, one end of said second flexible webbing attached to said second female attachment buckle, said second female attachment buckle releasably attached to said first male attachment buckle;
a second male attachment buckle, said second flexible webbing looped through a portion of said second male attachment buckle, said second male attachment buckle releasably attached to said first female attachment buckle; and
a second length adjustment slide, an opposite end of said second flexible webbing attached to said second length adjustment slide, said second adjustment slide used for expanding and contracting the length of said second flexible webbing.

10. The strap as described in claim 9 wherein said first and second flexible webbing includes a pair of parallel light reflective stripes, said stripes disposed along the length of said first and second webbing.
